(19) United States
(12) Patent Application Publication
(10) Pub. No.: US 2024/0351802 A1
(43) Pub. Date: Oct. 24, 2024

(54) A SORTING DEVICE

(71) Applicant: SYSTEM CERAMICS S.P.A., FIORANO MODENESE (IT)

(72) Inventor: ANDREA TORO, FIORANO MODENESE (IT)

(21) Appl. No.: 18/553,903

(22) PCT Filed: Apr. 11, 2022
(86) PCT No.: PCT/IB2022/053355

§ 371 Date: Oct. 4, 2023

(30) Foreign Application Priority Data
Apr. 21, 2021 (IT) 102021000010100

(51) Int. Cl. B65G 47/91; B65G 49/08

(52) U.S. Cl. CPC B65G 47/914; B65G 47/918; B65G 49/08; B65G 2201/02

(57) ABSTRACT

A sorting device for sheet-like products. such as ceramic slabs or tiles, having a main product conveyance direction (X), characterised in that it comprises a first manipulator (2), provided with gripping means (21), configured to connect to one or more products, which are aligned along a direction parallel to the main direction (X), in which the first manipulator (2) is movable along the main direction (X) between a pick-up position, in which the gripping means (21) is able to pick up one or more products. and a release position, in which the gripping means (21) is able to release the products.

The present invention relates to a sorting device, particularly, but not exclusively, for sheet-like products, such as ceramic slabs or tiles or panels or slabs in general such as glass panels, wood panels or slabs in general of different types of material.

In a production line of ceramic slabs or tiles, a transfer step is included in which the products, exiting the oven, are fed to a subsequent transport line.

For process economy, the products exiting the oven are deposited, by means of known devices, on transportable support surfaces, also called “platforms”. The products are arranged on the platforms with a matrix distribution, i.e., they are arranged according to a rectangular or square grid in relation to the shape and dimensions of the products and the platforms. The product matrix is commonly referred to as “quadrotta”, or square set of products.

Once loaded with products, the platforms are transported to a sorting device, which typically comprises a gripping means, for the plates or tiles supported on the platform, and a sorting system, which takes successive rows of products from the square set of products and feeds such rows to a conveyor, aligned with a predetermined transport direction.

The sorting devices currently available are quite complex. In fact, the gripping means is in the form of a rather bulky and heavy plate, associated with an anthropomorphic robotic arm or a portal structure. The plate is provided with suction cups or the like, configured to adhere to the products arranged on the platform so as to pick up the entire square set of products. The plate transfers the square set of products to the sorting system, which, in turn, comprises other handling systems, such as roller conveyors and belt conveyors, to separate the rows of products from the square set of products.

In addition to being rather bulky and complex, the current sorting devices are not very flexible with respect to a change in the size of the products, plates or tiles.

The object of the present invention is to provide a sorting device which enables the features of the current sorting devices to be improved.

An advantage of the present invention is that it makes it possible to considerably simplify the structure and footprint of the current sorting devices.

Another advantage of the present invention is to allow greater operating flexibility, quickly adapting to the changes in the size of the products.

Another advantage of the present invention is to allow the orderly transfer of the products with considerably reduced times with respect to the current sorting devices.

Additional features and advantages of the present invention will become more apparent from the following detailed description of an embodiment of the invention, illustrated by way of non-limiting example in the appended figures, in which:

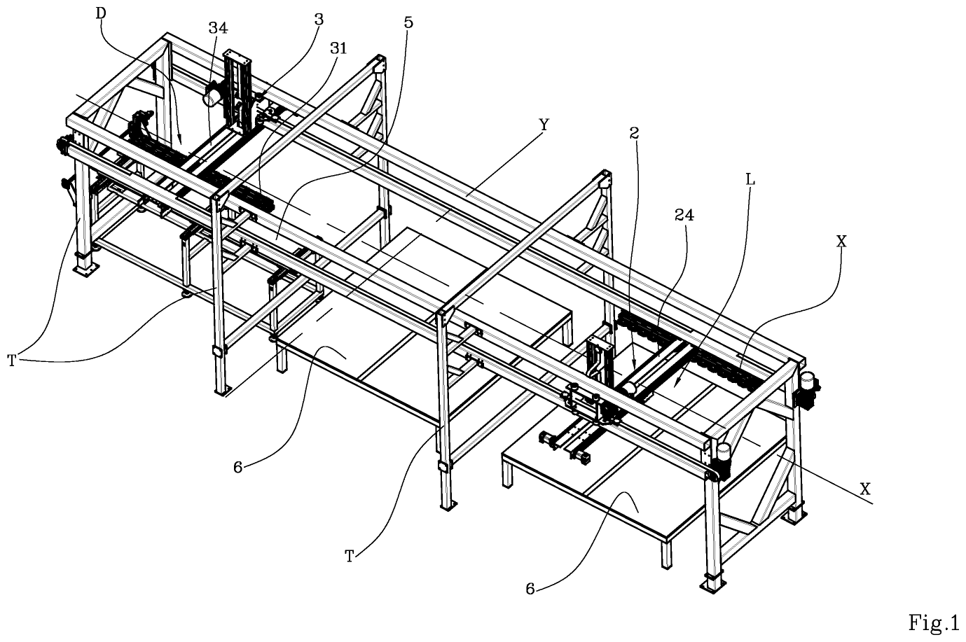

FIG. 1 shows an isometric view of the sorting device according to the present invention, in a first operating configuration;

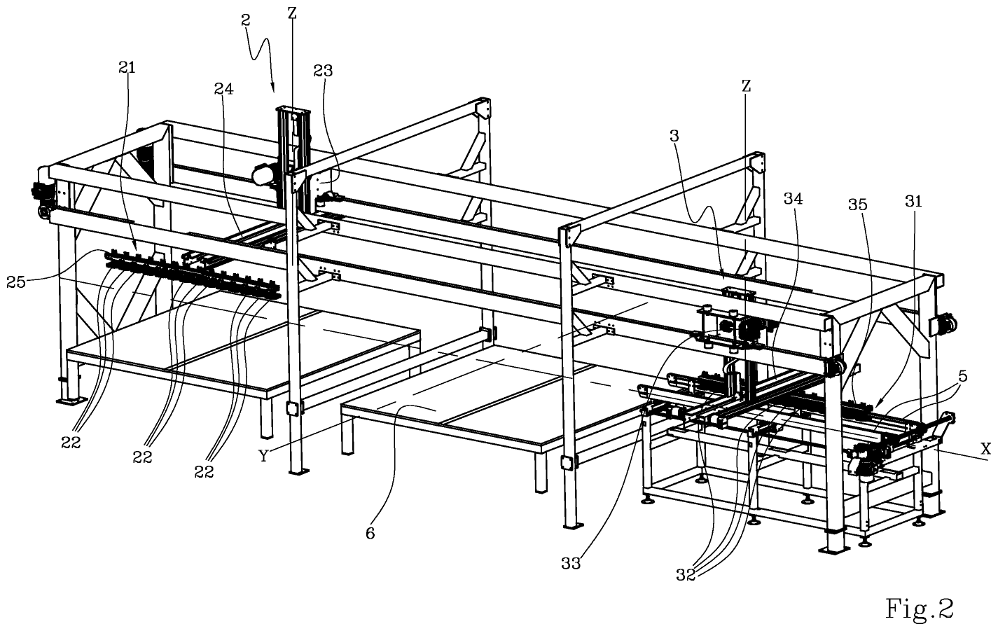

FIG. 2 shows a second isometric view of the device according to the present invention, from a different angle with respect to FIG. 1;

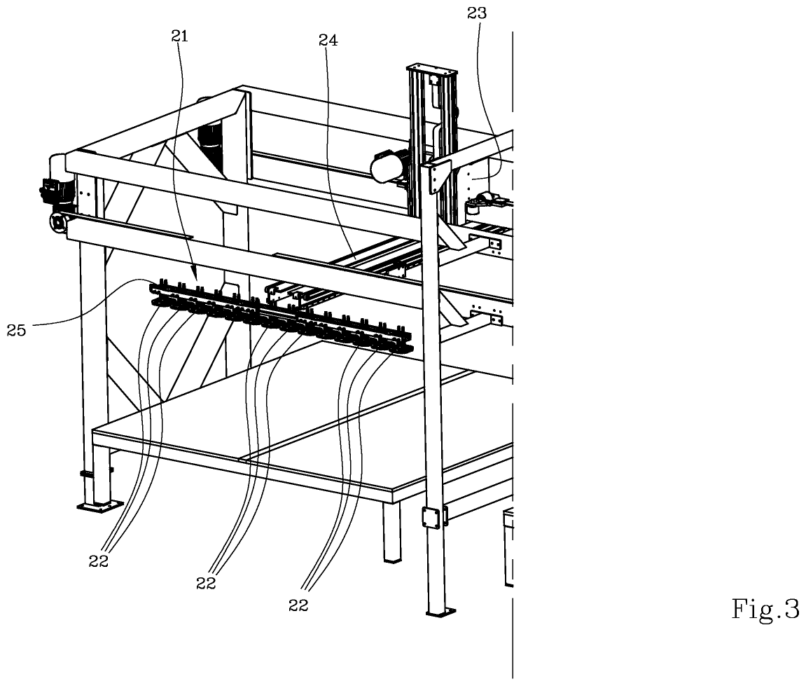

FIG. 3 shows an enlargement of FIG. 2;

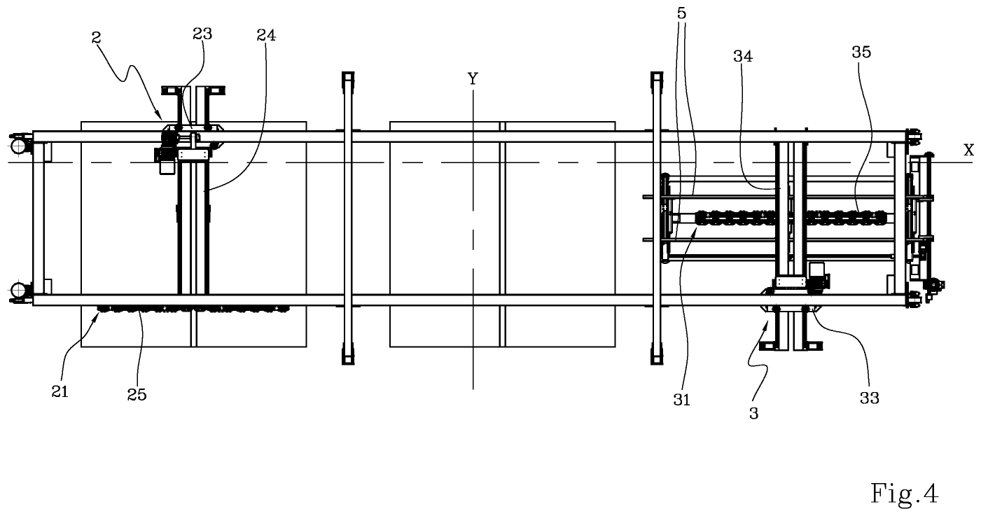

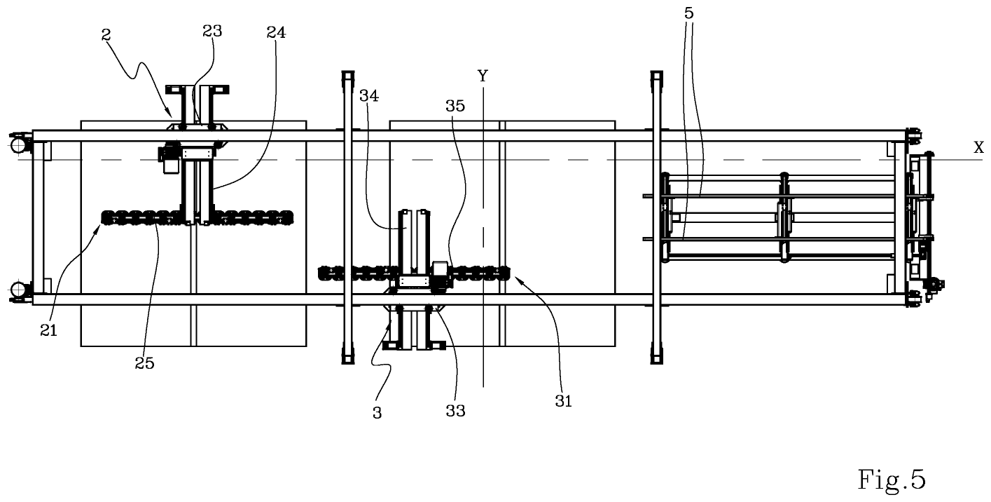

FIGS. 4 and 5 show two views from above of the device according to the present invention, in two different operating configurations.

The sorting device according to the present invention has a main product conveyance direction (X). Such a main direction (X) is the direction along which the products, for example ceramic slabs or tiles, are transferred from a first station (L) to a second station (D). To refer to products in the form of ceramic slabs or tiles, the term slabs will be generally used.

In the case of products in the form of ceramic slabs or tiles, the latter can be placed in the first station (L) by means of a known type of conveyance. As already mentioned in the introductory part of the description, typically the ceramic slabs, exiting the oven, are deposited in groups on conveyable support planes (6), also called platforms. The groups of slabs are configured in a matrix, i.e., the slabs are arranged according to a rectangular or square grid in relation to the shape and dimensions of the products and the platforms (6). The product matrix is said commonly referred to as “quadrotta”, or square set of products. Typically, the product matrix has rows of products aligned parallel to the main direction (X). In the case of slabs in the form of slats, the product matrix could comprise two or more slabs side by side and oriented parallel or perpendicular to the main direction (X).

The orientation device comprises a first manipulator (2), provided with gripping means (21). The gripping means (21) is configured to connect to one or more products. In the depicted, preferred but not exclusive embodiment, the gripping means (21) comprises two or more suction cups (22). As is known in the field, the suction cups (22), available in various embodiments for those skilled in the art, are particularly effective for adhering, on command, to the surface of the ceramic slabs.

Advantageously, the gripping means (21) is aligned along a direction parallel to the main direction (X). Furthermore, the first manipulator (2) is movable along the main direction (X) between a pick-up position, in which the gripping means (21) is able to pick up one or more products, and a release position, in which the gripping means (21) is able to release the products.

The arrangement of gripping means (21) aligned along a direction parallel to the main direction (X) and associated with the manipulator (2), in turn movable along the main direction (X), offers important advantages with respect to the prior art.

In fact, the gripping means (21), thanks to its alignment, is able to pick up one or more products oriented parallel to the main direction (X). For example, in the case of a square set of slabs, the gripping means (21) is able to pick up two or more slabs arranged along a row parallel to the main direction (X). Said row of slabs is substantially already oriented to be moved and deposited on a conveyor (5), which comprises a movable conveyance plane along the main direction (X), without further orientation motions in space, and without the need for further orientation devices.

In the depicted, preferred but not exclusive embodiment, the gripping means (21) of the first manipulator (2) is movable along a transverse direction (Y), perpendicular to the main direction (X). This allows the gripping means (21) to reach all the rows parallel to the main direction (X) which form the product matrix, i.e., the rows of ceramic slabs in the case depicted.

Furthermore, the gripping means (21) is preferably movable along a vertical axis (Z), between at least one upper position and at least one lower position. This allows the gripping means to be positioned at the correct height to pick up and unload the products.

In a possible embodiment, in which the gripping means (21) of the first manipulator (2) is rotatable about a substantially vertical rotation axis. This allows the gripping means to vary the orientation on a horizontal plane of the row of products, and/or to pick up a row of products not parallel to the main direction (X), and to subsequently orient said row along a direction parallel to the main direction (X).

As already indicated, the gripping means (21) of the first manipulator (2) comprises two or more suction cups (22), arranged aligned along a direction parallel to the main direction (X). Advantageously, the suction cups (22) can be activated independently of one another. In other words, each suction cup (22) can be activated and deactivated with a command independently of the other suction cups. Advantageously, the suction cups (22) can be activated by means of self-excluding valves with only one command. Thereby, the suction cups (22) can be activated individually, to each adhere to a single product, or they can be activated in groups of two or more suction cups, for example to simultaneously adhere to a larger product. Furthermore, any suction cups (22) which do not contribute to gripping a product can be deactivated, allowing in any case an energy saving.

In the depicted embodiment, the first manipulator (2) comprises a carriage (23), provided with a cross member (24) to which the gripping means (21) is associated. The carriage (23) is slidable, in a direction parallel to the main direction (X), along a guide integral with a frame (T) of the device. In particular, the sliding guide of the carriage (23) is located in a side area of the frame (T), so as to be located on the side of the area which, in operation, is occupied by the platforms (6). This allows the gripping means (21) to completely sweep the area occupied by the platforms (6), without being hindered by the carriage (23). The cross member (24) is oriented substantially horizontally and protrudes in shelves from the carriage (23), perpendicular to the main direction (X).

The gripping means (21) of the first manipulator (2) is movable along the cross member (24) in the transverse direction (Y). In the depicted embodiment, the gripping means (21) comprises a bar (25), slidably associated with the cross member (24). In particular, the bar (25) is oriented parallel to the main direction (X). The suction cups (22) are associated with the bar (25), aligned along the main direction (X) and facing downwards. Guides and motors of various types, known to those skilled in the art, can be used to allow the movement of the gripping means along the cross member (24), or to allow the translation of the bar (25) along the cross member (24).

Preferably, but not necessarily, the sorting device according to the present invention comprises a second manipulator (3). The second manipulator (3) is substantially equal to the first manipulator device (2), but is arranged specularly to the latter with respect to a median vertical plane of the device. Furthermore, the second manipulator (3) is controllable independently with respect to the first manipulator (2).

In particular, the second manipulator (3) is provided with gripping means (31) configured to connect to one or more products. In the depicted, preferred but not exclusive embodiment, the gripping means (31) of the second manipulator (3) comprises two or more suction cups (32).

As in the case of the first manipulator (2), the gripping means (31) of the second manipulator (3) is aligned along a direction parallel to the main direction (X). Furthermore, also the second manipulator (3) is movable along the main direction (X) between a pick-up position, in which the gripping means (31) is able to pick up one or more products, and a release position, in which the gripping means (31) is able to release the products. The arrangement of gripping means (31) aligned along a direction parallel to the main direction (X) and associated with the second manipulator (3), in turn movable along the main direction (X), offers the same advantages already described for the first manipulator (2), and further allows to considerably increase the productivity of the device. In fact, the two manipulators (2,3) can be driven alternately in forward and reverse strokes, i.e., while one performs a forward stroke from the pick-up position (L) to the unloading position (D), the other can perform the reverse stroke simultaneously. To this end, the two manipulators (2,3) are structured so as not to interfere with each other. Furthermore, the two manipulators (2,3) can be operated in synchrony, to carry out forward and reverse strokes at the same time, in the case of products of considerable weight and/or size, for which it may be necessary to support both gripping means (21,31).

Preferably, also gripping means (31) of the second manipulator (3), like the gripping means (21) of the first manipulator (2), is movable along a transverse direction (Y), perpendicular to the main direction (X). Thereby also the gripping means (31) of the second manipulator (3) is able to reach all the rows parallel to the main direction (X) which form the product matrix, i.e., the rows of ceramic slabs in the case depicted.

Furthermore, the gripping means (31) of the second manipulator (3) is preferably movable along a vertical axis (Z), between at least one upper position and at least one lower position. This allows the gripping means (31) to be positioned at the correct height to pick up and unload the products. The upper position of the gripping means (31) of the second manipulator (3) is positioned at a different height with respect to the upper position of the gripping means (21) of the first manipulator (2), i.e., above or below the latter.

In a possible embodiment, also the gripping means (31) of the second manipulator (3) is rotatable about a substantially vertical rotation axis. This allows the gripping means to vary the orientation on a horizontal plane of the row of products, and/or to pick up a row of products not parallel to the main direction (X), and to subsequently orient said row along a direction parallel to the main direction (X).

Also the gripping means (31) of the second manipulator (3) comprises, preferably, two or more suction cups (32), arranged aligned along a direction parallel to the main direction (X). The suction cups (32) can be activated independently of one another. As in the case of the first manipulator (2), each suction cup (32) of the second manipulator (3) can be activated and deactivated with a command independently of the other suction cups. For example, the suction cups (32) can be activated by means of self-excluding valves with only one command. Thereby, the suction cups (32) can be activated individually, to each adhere to a single product, or they can be activated in groups of two or more suction cups, for example to simultaneously adhere to a larger product. Furthermore, any suction cups (32) which do not contribute to gripping a product can be deactivated, allowing in any case an energy saving.

As already indicated, the second manipulator (3) has a structure substantially equal to that of the first manipulator (2), while being arranged specularly with respect to the latter with respect to a median vertical plane of the device.

In particular, the second manipulator (3) comprises a carriage (33), provided with a cross member (34) to which the gripping means (31) is associated. The carriage (33) is slidable, in a direction parallel to the main direction (X), along a guide integral with a frame (T) of the device. In particular, the sliding guide of the carriage (23) is located in a side area of the frame (T), so as to be located on the side of the area which, in operation, is occupied by the platforms (6), on an opposite side of the frame (T) with respect to that to which the sliding guide of the carriage (23) of the first manipulator (2) is integral. This allows the gripping means (31) to completely sweep the area occupied by the platforms (6), without being hindered by the carriage (33). The cross member (34) is oriented substantially horizontally and protrudes in shelves from the carriage (33), perpendicular to the main direction (X).

The gripping means (31) of the second manipulator (3) is movable along the cross member (34) in the transverse direction (Y). In the depicted embodiment, the gripping means (31) comprises a bar (35), slidably associated with the cross member (34). In particular, the bar (35) is oriented parallel to the main direction (X). The suction cups (32) are associated with the bar (35), aligned along the main direction (X) and facing downwards. Guides and motors of various types, known to those skilled in the art, can be used to allow the movement of the gripping means along the cross member (34), or to allow the translation of the bar (35) along the cross member (34).

The sorting device according to the present invention comprises a conveyor (5), movable along the main direction (X). The conveyor (5) is located in the second station (D). In the depicted embodiment, the conveyor (5) comprises a conveyance plane movable along the main direction (X). For example, the conveyor (5) is in the form of a roller or belt conveyor of a type widely known in the art.

The conveyor (5) is arranged to conduct the products to subsequent devices or stations, included in the production line, or to conduct the products to the first manipulator (2) or to the second manipulator (3), if the latter is present.

Advantageously, the first and/or the second manipulator (2,3), by virtue of the respective gripping means (21,31), picks up and deposits the products aligned along the main direction (X), in particular deposits the products on the conveyor (5) already aligned along the conveyance direction, i.e., along the main direction (X). Obviously the movement could be the opposite, i.e., a predetermined number of products aligned on the conveyor (5) along the main direction (X) could be picked up by the first and/or second manipulator, to be deposited elsewhere maintaining the alignment thereof. As already underlined, no further operations are necessary to orient or distribute the products so that they can be deposited on the conveyor (5).

The work cycle actuatable by the sorting device according to the present invention substantially occurs through the following steps.

A support plane (6), or platform, is located at the first station (L). A plurality of products are positioned on the support plane (6), ordered by matrix or square set of products, i.e., arranged in rows parallel to the main direction (X).

The first manipulator (2) can reach the first station (L), or it can already be in the first station (L), with the gripping means (21) in the upper position. The gripping means (21) then translates along the transverse direction (Y) to position itself above a selected row of products. Once the position above the selected row of products is reached, the gripping means (21) lowers into the lower position and couples the products belonging to the selected row. In the preferred embodiment, the coupling occurs by activating the suction cups (22).

Subsequently, the gripping means (21) is lifted in the upper position and, by means of the carriage (23), moves towards the second station (D). During such movement towards the second station (D), or at the end of such movement, the gripping means (21) translates along the transverse direction (Y) to align vertically with a predetermined unloading area. In the solution described, such a predetermined unloading area is defined by the conveyor (5), and in particular by an initial end section of the conveyor (5). Once the products have been deposited, the first manipulator (2) returns to the initial position.

In the presence of the second manipulator (3), the latter can perform a substantially inverse operation cycle with respect to the operation cycle carried out by the first manipulator (2).

In particular, while the first manipulator (2) performs its forward stroke from the first station (L) to the second station (D), the second manipulator (3) performs a reverse stroke from the second station (D) to the first station (L), and vice versa. In the first station, the second manipulator (3) picks up a selected row of products, with a sequence of movements of its gripping means (31) completely similar to the sequence of movements carried out by the gripping means (21) of the first manipulator (2). While the second manipulator (3) picks up a row of products, the first manipulator (2) deposits the row of products previously picked up, in the manner described above. Subsequently, while the first manipulator (2) returns to the first station (L), the second manipulator (3) moves to the second station (D), to deposit the products in the predetermined unloading area, for example the conveyor (5), with a sequence of movements of its gripping means (31) completely similar to the sequence of movements carried out by the gripping means (21) of the first manipulator (2) for depositing the products.

Advantageously, the sorting device according to the present invention can also be used to carry out a work cycle opposite to that described above, i.e., to deposit the products on the support planes (6), picking them up from the conveyor (5).

In practice, the operating sequences and the movements carried out by the first manipulator (2) and the second manipulator (3), if present, are the same described above, with the difference that, at the conveyor (5), the gripping means (21,31) grips a row of products, while at the support surface (6) the gripping means (21,31) deposits the row of products in a predetermined position on the support plane (6).

Also in this case, a support plane (6), or platform, is located at the first station (L). The products are fed in rows to the conveyor (5) which conducts them to the second station (D).

The first manipulator (2) can reach the second station (D), or it can already be in the second station (D), with the gripping means (21) in the upper position and aligned vertically with the conveyor (5). The gripping means (21) lowers into the lower position and couples a row of products, or a single elongated product. In the preferred embodiment, the coupling occurs by activating the suction cups (22).

Subsequently, the gripping means (21) is lifted into the upper position and, by means of the carriage (23), moves towards the first station (L). During such movement towards the first station (L), or at the end of such movement, the gripping means (21) translates along the transverse direction (Y) to align vertically with a predetermined unloading area. In the solution described, such a predetermined unloading area is defined by an area of the support plane (6), intended to receive the product or the row of products. The gripping means (21) lowers into the lower position and releases the products into the selected position. The release occurs by deactivating the suction cups (22).

Also in this case, in the presence of the second manipulator (3), the latter can perform a substantially inverse operation cycle with respect to the operation cycle carried out by the first manipulator (2).

In particular, while the first manipulator (2) performs its forward stroke from the second station (D) to the first station (L), the second manipulator (3) performs a reverse stroke from the first station (L) to the second station (D), and vice versa. In the second station (D), the second manipulator (3) picks up a row of products, with a sequence of movements of its gripping means (31) completely similar to the sequence of movements carried out by the gripping means (21) of the first manipulator (2). While the second manipulator (3) picks up a row of products, the first manipulator (2) deposits the row of products previously picked up, in the manner described above. Subsequently, while the first manipulator (2) returns to the second station (D), the second manipulator (3) moves to the first station (L), to deposit the products in the predetermined unloading area on the support plane (6), with a sequence of movements of its gripping means (31) completely similar to the sequence of movements carried out by the gripping means (21) of the first manipulator (2) for depositing the products. By virtue of the possibility of carrying out the cycle of operations described above, to deposit the products on a support plane (6), the sorting device according to the present invention can be located at various points of the production line. For example, the sorting device can be placed at the outlet of an oven, to form the groups of products ordered in a matrix, or to form the square sets of products intended to be conveyed elsewhere.

1. A sorting device for sheet-like products, having a main product conveyance direction (X),
the sorting device comprises a first manipulator (2), provided with gripping means (21), configured to connect to one or more products, which are aligned along a direction parallel to the main direction (X);
the first manipulator (2) is movable along the main direction (X) between a pick-up position, in which the gripping means (21) is able to pick up one or more products, and a release position, in which the gripping means (21) is able to release the products;
the gripping means (21) of the first manipulator (2) is movable along a transverse direction (Y), perpendicular to the main direction (X).

2. The device according to claim 1, further comprising a conveyor (5), movable along a main direction (X) and arranged to support one or more sheet-like products;
the gripping means (21) of the first manipulator (2) is movable along the transverse direction (Y), so as to reach the conveyor (5) to deposit or pick up one or more sheet-like products.

3. The device according to claim 1, wherein the gripping means (21) of the first manipulator (2) comprises two or more suction cups (22), arranged aligned along a direction parallel to the main direction (X), which are activatable independently of each other.

4. The device according to claim 1, wherein the first manipulator (2) comprises a carriage (23), provided with a cross member (24) with which the gripping means (21) is associated.

5. The device according to claim 4, wherein the gripping means (21) of the first manipulator (2) is movable along the cross member (24) in the transverse direction (Y).

6. The device according to claim 1, wherein the gripping means (21) of the first manipulator (2) rotates about a substantially vertical rotation axis (Z).

7. The device according to claim 1, further comprising a second manipulator (3), provided with gripping means (31) configured to connect to one or more products, which are aligned along a direction parallel to the main direction (X), wherein the second manipulator (3) is movable along the main direction (X) between a pick-up position, in which the gripping means (31) is able to pick up one or more products, and a release position, in which the gripping means (31) is able to release the products.

8. The device according to claim 7, wherein the gripping means (31) of the second manipulator (3) is movable along a transverse direction (Y), perpendicular to the main direction (X).

9. The device according to claim 7, wherein the gripping means (31) of the second manipulator (3) comprises two or more suction cups (32), arranged aligned along a direction parallel to the main direction (X), which are activatable independently of each other.

10. The device according to claim 7, wherein the second manipulator (3) comprises a carriage (33), provided with a cross member (34) with which the gripping means (31) is associated.

11. The device according to claim 10, wherein the gripping means (31) of the second manipulator (3) is movable along the cross member (34) in the transverse direction (Y).

12. The device according to claim 7, wherein the gripping means (31) of the second manipulator (3) rotates about a substantially vertical rotation axis (Z).

13. The device according to claim 7, wherein the first manipulator (2) and the second manipulator (3) are independently movable from one another along the main direction (X).
